(19) United States
(12) Patent Application Publication
(10) Pub. No.: US 2023/0076877 A1
(43) Pub. Date: Mar. 9, 2023

(54) METHOD AND SOFTWRE FOR SELECTION OF BACKGROUND IMAGE FOR A DISPLAY SCREEN OR SOFTWARE OUTPUT WINDOW

(71) Applicants: Mohammad Shafikul Huq, HAMTRAMCK, MI (US); Shakura Quabili, HAMTRAMCK, MI (US)

(72) Inventor: Mohammad Shafikul Huq, Hamtramck, MI (US)

(73) Assignees: Mohammad S Huq, HAMTRAMCK, MI (US); shakura s quabili, HAMTRAMCK, MI (US)

(21) Appl. No.: 17/881,591

(22) Filed: Aug. 4, 2022

Related U.S. Application Data
(60) Provisional application No. 63/241,057, filed on Sep. 6, 2021.

(51) Int. Cl. G06F 3/14; G06F 3/0481; G06F 9/451

(52) U.S. Cl. CPC G06F 3/14; G06F 3/0481; G06F 9/451

(57) ABSTRACT

The present invention is a method and software for background image selection for an electronic device that has a background image in its display screen or for a software that has display window with a background image. The method needs an optical image to provide image of a subject. The subject could be part of surrounding or the user itself. The methos analyzes the image and determine characteristics of the subject such as its color, speed, texture, etc. that relate to look and feel of the subject. This set of characteristics are then converted to another set of desired characteristics. A background image is then chosen from a library of images, created artificially, or modified from another image so that it matches the desired characteristics.

### FIELD OF THE INVENTION

The present invention relates to any display screen or software output window that has a background image. For instance, a cell phone display screen that works as a display for different icons of installed applications, or an output window of a remote conference meeting among people where there is a background image for each person posing as the foreground of the window.

### CROSS REFERENCE TO RELATED APPLICATION

This application is a continuation application of U.S. Provisional Pat. Application No. 63/241057, filed Sep. 06, 2021 with conformation number 1593, the contents of which are incorporated herein by reference almost in their entirety, with claims unchanged.

### BACKGROUND

Display screens are common in everyday life. Cell phones, computers, software such as virtual remote meeting software, etc. have display screens or windows where there is a foreground subject and there is a background image behind the foreground subject.

It is desired in many scenarios that the background image is in some way meaningful with respect to the foreground subject. For instance, a cell phone screen background image would be more appealing if it has the background image matching color of the environment around the cell phone or if it matches the color or designs of its owner’s clothing.

Therefore, a demand exists for a method and software that selects a background image that some way relates to a foreground, or surrounding environment, or the user.

### BRIEF SUMMARY OF THE INVENTION

The present invention is a method and software for background image selection for an electronic device that has a background image in its display screen or for a software that has output window with a background image. The method needs an optical sensor to provide image of a subject. The subject could be surrounding environment or the user of the electronic device itself. The method analyzes the image and determine characteristics of the subject such as its color, motion status, texture, etc. that relate to look and feel of the subject. This set of characteristics are then converted into another set of desired characteristics. A background image is then chosen from a library of images, created artificially, or modified from another image so that it matches the desired characteristics.

### DETAILED DESCRIPTION OF THE INVENTION

The terminology used herein for the purpose of describing the system and method is not intended to be limiting the invention. The term “and/or” includes any and all combinations of one or more of the associated listed items. As used herein, the singular forms “a,” “an”, and “the” are intended to include the plural forms as well as singular forms, unless the context clearly indicates otherwise. The term “comprising” and/or “comprises” specify the presence, when used in this specification, specify the presence of stated features, steps operations, elements, and/r components, but do not preclude the presence or addition of one or more other features, steps, operations, elements, components, and/or groups/thereof.

If not otherwise defined, all terms used herein have the same meaning as commonly understood by one having ordinary skill in the art to which this invention belongs. Furthermore, terms, such as those defined in commonly used dictionaries, should be interpreted as having a meaning that is consistent with their meaning in the context of the relevant art and the present invention and will not be interpreted in an idealized or overly formal sense unless expressly so defined herein.

In the description of the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. However, the specification and claims should be read with the understanding that such combinations are entirely within the scope of the invention and the claims.

The present invention is a method and software for background image selection for an electronic device that has a background image in its display screen or for a software that has output window with a background image. The method needs an optical sensor to provide image of a subject. The sensor is usually attached to the display screen. The subject could be surrounding environment or the user of the electronic device itself. For instance, for a conference meeting between two persons the subject is the person looking participating the conference meeting and the background is anything other than the person a camera is looking at. For a cell phone, the subject is environment around the user of the cell phone or the user of the cell phone itself and the background image is the display screen background image of the cell phone. The method analyzes image of the subject and determines characteristics of the subject such as its color, motion status, texture, etc. that relate to the look and feel of the subject. This set of characteristics are then converted into another set of desired characteristics. A background image is then chosen from a library of images, or is created artificially, or is modified from another image so that it matches the desired characteristics.

1. A method that captures images of subjects with cameras and then analyze the images to choose a background image of a display screen or software output window so that the image in some way matches or comply with characteristics of the subject, the said method comprising steps:
capturing images of a subject with an optical sensor;
process and analyze the image to find some characteristics of the subject;
convert the characteristics into desired characteristics that a background image should hold;
select an image from a library of images or artificially create/modify an image so that the selected or created or modified image in some way matches or comply with the desired characteristics; and
use the selected or created or modified image as a background image in the screen of an electronic device.

2. The method as described in claim 1, where the said subjects could be the environment around or the user of an electronic device having a display screen or in the case of a video conference software output window, the subject is the person appearing in the video conference.

3. A software that implements the method as defined in claim 1.
